(19) United States
(12) Patent Application Publication
(10) Pub. No.: US 2017/0334247 A1
(43) Pub. Date: Nov. 23, 2017

(54) Pneumatic Vehicle Tires

(71) Applicant: Continental Reifen Deutschland GmbH, Hannover (DE)

(72) Inventor: Julian De Riva-Perez, Hannover (DE)

(73) Assignee: Continental Reifen Deutschland GmbH, Hannover (DE)

(21) Appl. No.: 15/525,105

(22) PCT Filed: Aug. 3, 2015
(86) PCT No.: PCT/EP2015/067789

§ 371 Date: May 8, 2017

(30) Foreign Application Priority Data
Nov. 11, 2014 (DE) 10 2014 222 921.9

(51) Int. Cl. B60C 9/22

(52) U.S. Cl. CPC B60C 9/2204; B60C 2009/2285; B60C 2009/2257; B60C 2009/2214; B60C 2009/2219; B60C 2009/2223

(57) ABSTRACT

The invention relates to radial-type pneumatic vehicle tires comprising at least one carcass layer (3), a profiled tread (1), a two-layer belt (2), and a belt bandage (6) which covers the belt and which comprises bandage cords that run in the circumferential direction of the tire and consist of at least one thread made of a textile material. The belt bandage (6) has a central bandage part (7) and two lateral bandage parts (8), wherein the central bandage part (7) reaches laterally beyond the edges of the radially outer belt layer (2b), and the two lateral bandage parts (8) adjoin the central bandage part (7), cover the respective remaining edge portion of the two belt layers (2b), and run axially outside of the edges of the radially inner belt layer (2a) so as to contact a carcass layer (3) portion with a width of up to 15 mm. The bandage cord in the central bandage part (7) consists of a single thread, and the bandage cord in the lateral bandage parts (8) consists of two threads twisted together.

The invention relates to a pneumatic vehicle tire of a radial type, comprising at least a carcass ply, a profiled tread, a two-ply breaker belt and a belt bandage covering the latter, with bandage cords that run in the circumferential direction of the tire and consist of at least one yarn of a textile material.

It is known and customary to cover the breaker belt of pneumatic vehicle tires with a one-ply or two-ply belt bandage, which is produced by winding one or more strips of rubber compound in which the bandage cords are embedded. Bandage cords usually consist of heat-shrinkable textile materials, for example of nylon, which becomes somewhat shortened during the vulcanizing of the tire, and thereby firmly bandages the breaker belt. Belt bandages contribute to a reduction in the rolling resistance, accompanied by greater comfort and good high-speed suitability. Nylon 6.6 in the construction 940×2 (two twisted-together nylon yarns of 940 dtex) is used for example as a bandage cord, or a bandage cord of a twisted-together nylon yarn, in particular likewise of 940 dtex, is used. In the case of most tire structures, the belt bandage covering over and overlapping the edges of the breaker belt comes into contact with the carcass ply axially outside the wider, radially inner belt ply. When bandage cords formed from a single yarn are used, the aforementioned firm bandaging of the breaker belt by the belt bandage may lead to the bandage cords cutting through or severing the cords in the carcass ply. When a bandage cord of two yarns such as that described is used, there is no risk of the carcass cords being severed. However, bandage plies with such “double cords” on the one hand increase the weight of the tire and the rolling resistance during the rolling of the tire and on the other hand are relatively expensive in comparison with single cords.

The invention is based on the object of designing a pneumatic vehicle tire of the type mentioned at the beginning in such a way that severing of the carcass cords by the bandage cord to the sides of the breaker belt is avoided, while it is intended for the belt bandage to be of a low-cost design and of as little weight as possible.

The set object is achieved according to the invention by the belt bandage having a central bandage part and two lateral bandage parts, the central bandage part reaching laterally beyond the edges of the radially outer belt ply and the two lateral bandage parts adjoining the central bandage part, respectively covering the remaining peripheral portion of the second belt ply and running axially outside the edges of the radially inner belt ply while in contact with a portion up to 15 mm wide of the carcass ply, the bandage cord in the central bandage part consisting of a single yarn and the bandage cord in the lateral bandage parts consisting of two twisted-together yarns.

According to the invention, a bandage cord consisting of two yarns is therefore only present in those regions or portions of the belt bandage where there is the risk of the carcass cords being severed, that is to say the lateral regions. The use of a bandage cord of two yarns avoids severing of the carcass cords. In the central bandage part, taking up by far the greatest part of the belt bandage, a bandage cord that not only costs significantly less than the bandage cord in the lateral bandage parts but is also advantageous for the weight of the tire, and consequently for the rolling resistance, is used.

In the case of pneumatic vehicle tires designed according to the invention, the portions of the carcass ply that are covered by the lateral bandage parts may have a width of 3 mm to 20 mm.

In the case of a preferred embodiment of the invention, the yarn or the yarns of the bandage cord consists or consist of a polyamide, in particular of nylon 6.6. In the case of an alternative embodiment, the yarn or the yarns may also consist of polyester. In this case it is possible that the bandage cord in the central bandage part consists of a different material than the bandage cord in the lateral bandage parts. The materials mentioned are materials that are easily available and low in cost.

Depending on the structural design of the tire and depending on the intended use, bandage cords of yarns that have a certain fineness are used. The bandage cord of the central bandage part and the lateral bandage parts is preferably produced from a polyamide yarn that has a fineness of 700 dtex to 1800 dtex, in particular of 940 dtex to 1400 dtex. In the case of a particularly preferred embodiment, the bandage cord in the central bandage part is a polyamide cord 940×1, the bandage cord in the lateral bandage parts is a polyamide cord 940×2.

Depending on the intended use, the bandage parts are of a one-ply or multi-ply design. Thus, in particular, the central bandage part is of a one-ply or two-ply design, the lateral bandage parts are of a one-ply to three-ply design.

Other features, advantages and details of the invention are now described in more detail on the basis of the schematic drawing, which shows exemplary embodiments of the invention. In the drawing:

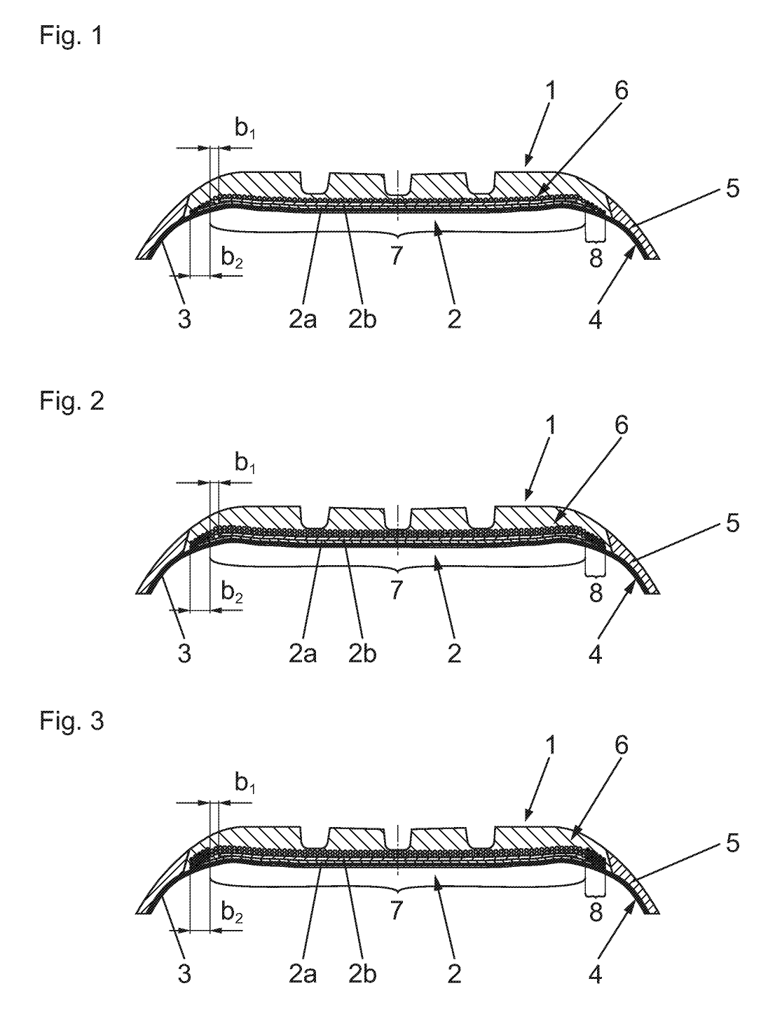

FIG. 1 to FIG. 3 respectively show a cross section through a pneumatic vehicle tire in the region of the tread with a design variant of the invention.

Pneumatic vehicle tires designed according to the invention are tires of a radial type for passenger cars or vans. In the case of the design variants shown in FIGS. 1 to 3, the pneumatic vehicle tire has a profiled tread 1, a breaker belt 2, a radial carcass 3, in particular of one ply, an inner layer 4, sidewalls 5, of which the radially outer end portions are shown, and also a belt bandage 6. Not shown are the bead regions with tension-resistant bead cores and bead fillers. As known per se, the radial carcass 3 is anchored in the bead regions by wrapping around the tension-resistant bead cores.

The breaker belt 2 has two belt plies 2a, 2b, the radially inner belt ply 2a being wider than the radially outer belt ply 2b. The belt plies 2a, 2b consist in a way known per se of reinforcing elements, in particular of steel cord, embedded in a rubber compound, which in each ply 2a, 2b run parallel to one another and at an acute angle of in particular 24° to 28° in relation to the circumferential direction, the reinforcing elements in the one belt ply 2a crossing the reinforcing elements in the other belt ply 2b. The tire shown is also made in such a way that the sidewalls 5 end laterally of the tread 1. In the case of another variant that is not shown, the sidewalls reach up to just before the edges or ends of the belt.

The belt bandage 6 consists of a central bandage part 7 and two lateral bandage parts 8. The central bandage part 7 is designed or produced in a width that is slightly greater than the width of the radially outer belt ply 2b, so that, although the central bandage part 7 covers over the lateral edges of the belt ply 2b, it does not cover over the lateral edges of the belt ply 2a. The width bi of the covering-over portion is in particular 2 mm to 5 mm. The two lateral bandage parts 8 directly adjoin the central bandage part 7 and cover over the lateral edges of the radially inner belt ply 2a. Axially outside the belt ply 2a , the two lateral bandage parts 7 are in contact with the carcass ply 3. The width b₂ of the portion of the lateral bandage parts 8 that is overlapping the belt edges of the belt ply 2a is of the order of magnitude of 3 mm to 20 mm. Both the central bandage part 7 and the lateral bandage parts 8 are produced as a wound bandage. A wound bandage is usually wound spirally onto the breaker belt 2 from at least one strip of bandage cord that is embedded in an unvulcanized rubber compound and runs in the longitudinal direction of the strip and, in the finished tire, consequently in or virtually in the circumferential direction. The winding may be performed in such a way that the individual turns of the respective strip butt against one another or partly overlap. Furthermore, winding with a gap is conceivable, a small distance remaining between the turns. The rubber compound strips used for producing wound bandages usually have a width of 8 mm to 12 mm; the mutual spacing of the reinforcing elements within the rubber compound strips is at least 0.2 mm; the mutual spacing is usually chosen such that the thread density in the belt bandage is 80 epdm (ends per decimeter) to 125 epdm.

The bandage cord in the central bandage part 7 is a “single cord”, which consists of a twisted-together yarn, to be precise preferably of a polyamide or of polyester. The polyamide of the bandage cord is in particular nylon 6.6; the polyester may be selected from the group consisting of polyethylene terephthalate, polyethylene naphthalate, polybutylene terephthalate and polycarbonate. The polyamide used for producing the single cord has a fineness of 700 dtex to 1800 dtex, in particular of 940 dtex to 1400 dtex; of the polyamide 6.6 yarns that are currently available on the market, a yarn with 940 dtex or 1400 dtex therefore comes into consideration for example. Of the polyester yarns, in particular those with a fineness of 1440 dtex are used.

The lateral bandage parts 7 are wound from a strip of rubber compound which contains a “double cord” as the bandage cord. The bandage cord consists of two identical yarns, which are twisted together and consist either of a polyamide or a polyester, as described for the single cord. The “double cord” is for example a cord of nylon with the construction 940×2 or 1400×2. The bandage cord in the central bandage part 7 may consist of a different material than the yarns of the bandage cord in the two lateral bandage parts 8.

FIGS. 1 to 3 show different design variants of belt bandages 6, which, in accordance with the concept according to the invention, have a central bandage part 7 and lateral bandage parts 8. In the case of the embodiment shown in FIG. 1, in the central bandage part 7 and in the two lateral bandage parts 8 the respective bandage cords are present as one ply. As mentioned, in this case the bandage parts 7, 8 are produced as a wound bandage comprising strips of rubber compound that contain the corresponding cords. The winding pattern shown in FIG. 1 is referred to as 1-1-1. In the case of the design variant shown in FIG. 2, the central bandage part 7 has two bandage plies, that is to say two plies of bandage cords, produced from a wound bandage by winding two plies. The two lateral bandage parts 8 likewise consist of two plies wound one over the other, therefore of two plies of bandage cords; the winding pattern is therefore 2-2-2. FIG. 3 shows a design variant in which two bandage plies have been produced in the central bandage part 7 and three bandage plies are respectively provided in the lateral bandage parts 8; the associated winding pattern is therefore 3-2-3.

The invention is not restricted to the exemplary embodiments shown; the central bandage part and the lateral bandage parts may also be produced with different winding patterns than those illustrated.

### LIST OF DESIGNATIONS

1 . . . Tread

2 . . . Breaker belt

2a, 2b . . . Belt ply

3 . . . Carcass ply

4 . . . Inner layer

5 . . . Sidewall

6 . . . Belt bandage

7 . . . Bandage part

8 . . . Bandage part

b₁, b₂ . . . Width

1.-11. (canceled)

12. A pneumatic vehicle radial tire comprising a carcass ply, a profiled tread, a two-ply breaker belt and a belt bandage covering the two-ply breaker belt, wherein the belt bandage comprises bandage cords that run in the circumferential direction of the tire and comprise at least one yarn of a textile material;
wherein the belt bandage further comprises a central bandage part and two lateral bandage parts, wherein the central bandage part extends laterally beyond edges of a radially outer belt ply and the two lateral bandage parts adjoining the central bandage part, and the central bandage part respectively covering the remaining peripheral portion of the second belt ply and running axially outside the edges of the radially inner belt ply while in contact with a portion up to 15 mm wide of the carcass ply; and,
wherein the bandage cord in the central bandage part comprises a single yarn and the bandage cords in the lateral bandage parts comprises two twisted-together yarns.

13. The pneumatic vehicle radial tire as claimed in claim 12, wherein the portions of the carcass ply that are covered by the lateral bandage parts have a width (b2) of 3 mm to 20 mm.

14. The pneumatic vehicle radial tire as claimed in claim 12, wherein the at least one yarn comprised in the bandage cords comprise a polyamide yarn.

15. The pneumatic vehicle radial tire as claimed in claim 12, wherein the at least one yarn comprised in the bandage cords comprise a polyester yarn.

16. The pneumatic vehicle radial tire as claimed in claim 15, wherein the polyester yarn is selected from the group consisting of polyethylene terephthalate yarn, polyethylene naphthalate yarn, polybutylene terephthalate yarn and polycarbonate yarn.

17. The pneumatic vehicle radial tire as claimed in claim 12, wherein the at least one yarn of the bandage cord in the central bandage part has a fineness of 700 dtex to 1800 dtex.

18. The pneumatic vehicle radial tire as claimed in claim 12, wherein the at least one yarn of the bandage cord in the lateral bandage parts has a fineness of 700 dtex to 1800 dtex.

19. The pneumatic vehicle radial tire as claimed in claim 12, wherein the bandage cord in the central bandage part is a polyamide cord 940×1.

20. The pneumatic vehicle radial tire as claimed in claim 12, wherein the bandage cord in the lateral bandage parts is a polyamide cord 940×2.

21. The pneumatic vehicle radial tire as claimed in claim 12, wherein the central bandage part is of a one-ply or two-ply design.

22. The pneumatic vehicle radial tire as claimed in claim 12, wherein the lateral bandage parts are of a one-ply to three-ply design.
